(19) United States
(12) Patent Application Publication
(10) Pub. No.: US 2013/0073451 A1
(43) Pub. Date: Mar. 21, 2013

(54) SYSTEM AND METHOD FOR PROVIDING BALANCE TRANSFERS

(71) Applicant: Capital One Financial Corporation, McLean, VA (US)

(72) Inventor: Mark Richard JAMISON, Mill Valley, CA (US)

(73) Assignee: CAPITAL ONE FINANCIAL CORPORATION, McLean, VA (US)

(21) Appl. No.: 13/623,531

(22) Filed: Sep. 20, 2012

Related U.S. Application Data
(60) Provisional application No. 61/536,832, filed on Sep. 20, 2011.

(51) Int. Cl. G06Q 20/32

(52) U.S. Cl. 705/39

(57) ABSTRACT

Techniques for providing balance transfers are disclosed. In one exemplary embodiment, the techniques may be realized in a system or computer-implemented method for providing a balance transfer offer to a customer. The customer may initiate the balance transfer by acquiring existing account balance information and providing the account balance information to an application. The customer may take a photograph of an existing account statement with a mobile device, and data from the existing account statement may be extracted and automatically provided to a balance transfer application. The customer may then verify certain customer information, be presented with balance transfer options, and confirm that the customer would like to complete the balance transfer.

### CROSS-REFERENCE TO RELATED APPLICATIONS

This application claims priority to U.S. Provisional Patent Application No. 61/536,832, filed Sep. 20, 2011, which is hereby incorporated by reference in its entirety.

### FIELD OF THE DISCLOSURE

The present invention relates to systems and methods for providing balance transfers.

### BACKGROUND OF THE DISCLOSURE

Financial institutions may provide customers or potential customers with balance transfer offers. Such offers may permit a customer or potential customer to transfer an account balance, or part of an account balance, to another account. Oftentimes, the new account may be held at a different financial institution.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts a system for providing balance transfers;

FIG. 2 depicts an exemplary screenshot of a user interface for providing log in information;

FIG. 3 depicts an exemplary screenshot of a user interface for selecting banking options;

FIG. 4 depicts an exemplary screenshot of a user interface for selecting a balance transfer banking option;

FIG. 5 depicts an exemplary screenshot of a manage credit card accounts user interface;

FIG. 6 depicts an exemplary screenshot of a balance transfer user interface;

FIG. 7 depicts an exemplary screenshot of a balance transfer user interface;

FIG. 8 depicts an exemplary screenshot of a captured account statement;

FIG. 9 depicts an exemplary screenshot of a captured account statement;

FIG. 10 depicts an exemplary screenshot of an image processing screen;

FIG. 11 depicts an exemplary screenshot of extracted account data;

FIG. 12 depicts an exemplary screenshot of extracted account data;

FIG. 13 depicts an exemplary screenshot of a savings calculation screen;

FIG. 14 depicts an exemplary screenshot of a savings indication screen;

FIG. 15 depicts an exemplary screenshot of a savings indication screen;

FIG. 16 depicts an exemplary screenshot of a savings indication screen;

FIG. 17 depicts an exemplary screenshot of a balance transfer screen;

FIG. 18 depicts an exemplary screenshot of a confirm balance transfer screen;

FIG. 19 depicts an exemplary screenshot of a balance transfer confirmation screen; and

FIG. 20 is a flow chart illustrating a method for providing balance transfers.

### DETAILED DESCRIPTION OF THE EMBODIMENTS

The following description is intended to convey a thorough understanding of the embodiments described by providing a number of specific exemplary embodiments and details involving systems and methods for providing balance transfers. It should be appreciated, however, that the present disclosure is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure. The disclosure is not intended to be limited to financial institutions only.

According to the various embodiments of the present disclosure, a financial institution may provide a balance transfer offer to a customer. The customer may initiate the balance transfer by acquiring existing account balance information and providing the account balance information to an application. For example, a customer may take a photograph of an existing account statement with a mobile device, and data from the existing account statement may be extracted (using, for example, optical character recognition or other image analysis techniques) and automatically populated (or provided to) in a balance transfer application. The customer may then verify certain customer information, be presented with balance transfer options, and confirm that the customer would like to complete the balance transfer.

It should be understood that the term “balance transfer” may relate to any number of account transfer and account transfer offers that may be provided by a financial institution. By way of a non-limiting example, “balance transfer” may refer to a transfers between credit card accounts or between an outstanding auto loan and a credit card account and the like.

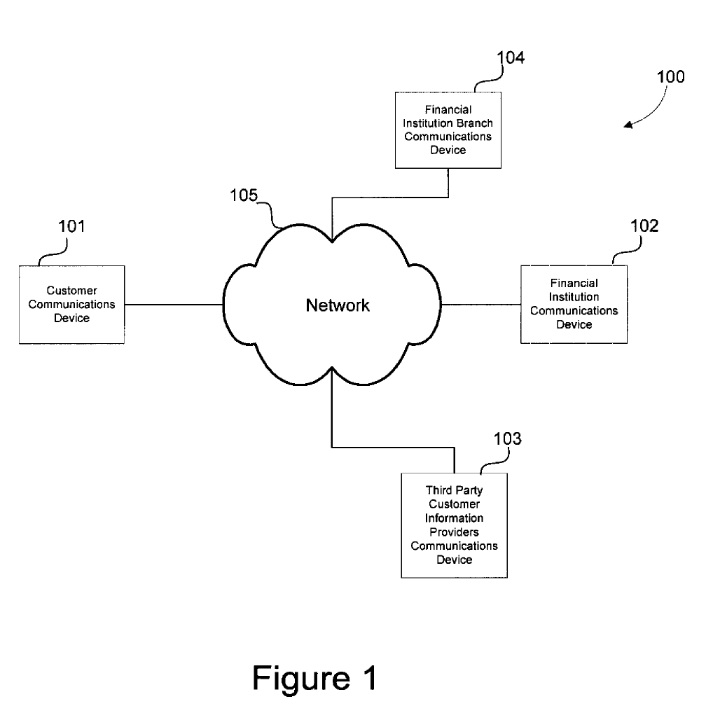

FIG. 1 depicts a system 100 for providing balance transfers, in accordance with exemplary embodiments. As illustrated, system 100 may include one or more networks, such as network 105. Network 105 may be one or more of a wireless network, a wired network or any combination of wireless network and wired network. For example, network 105 may include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11b, 802.15.1, 802.11n and 802.11g or any other wired or wireless network for transmitting and receiving a data signal.

In addition, network 105 may include, without limitation, telephone lines, fiber optics, IEEE Ethernet 902.3, a wide area network (“WAN”), a local area network (“LAN”), or a global network such as the Internet. Also network 105 may support an Internet network, a wireless communication network, a cellular network, or the like, or any combination thereof. Network 105 may further include one network, or any number of the exemplary types of networks mentioned above, operating as a stand-alone network or in cooperation with each other. Network 105 may utilize one or more protocols of one or more network elements to which they are communicatively coupled. Network 105 may translate to or from other protocols to one or more protocols of network devices. Although network 105 is depicted as a single network, it should be appreciated that according to one or more embodiments, network 105 may comprise a plurality of interconnected networks, such as, for example, the Internet, a service provider's network, a cable television network, corporate networks, and home networks.

Customers may access network 105 through one or more customer communications devices 101 that may be communicatively coupled to network 105. A financial institution may access network 105 through one or more financial institution communications devices 102 that may be communicatively coupled to network 105. A financial institution branch may access network 105 through one or more financial institution branch communications devices 104 that may be communicatively coupled to network 105. Third party customer information providers may access network 105 through one or more third party communication devices 103 that may be communicatively coupled to network 105. Communication devices 101, 102, 103, and 104 may include, for example, smart phones, wireless phones, Personal Digital Assistants (PDA), desktop computers, laptop computers, servers, other computers or any combination thereof. Communications devices 101, 102, 103, and/or 104 may include an external or internal camera.

Customer communications devices 101, financial institution communications devices 102, financial institution branches communications devices 104, and third party customer information providers communications devices 103 may send and receive data using one or more protocols. For example, data may be transmitted and received using Wireless Application Protocol (WAP), Multimedia Messaging Service (MMS), Enhanced Messaging Service (EMS), Short Message Service (SMS), Global System for Mobile Communications (GSM) based systems, Time Division Multiplexing (TDM) based systems, Code Division Multiple Access (CDMA) based systems suitable for transmitting and receiving data. Data may be transmitted and received wirelessly or may utilize cabled network connection or telecom connections, fiber connections, traditional phone wireline connection, a cable connection or other wired network connection.

It should be appreciated the foregoing discussion related to FIG. 1 is illustrative only, and that the various embodiments of the invention may be implemented by any other appropriate system or method.

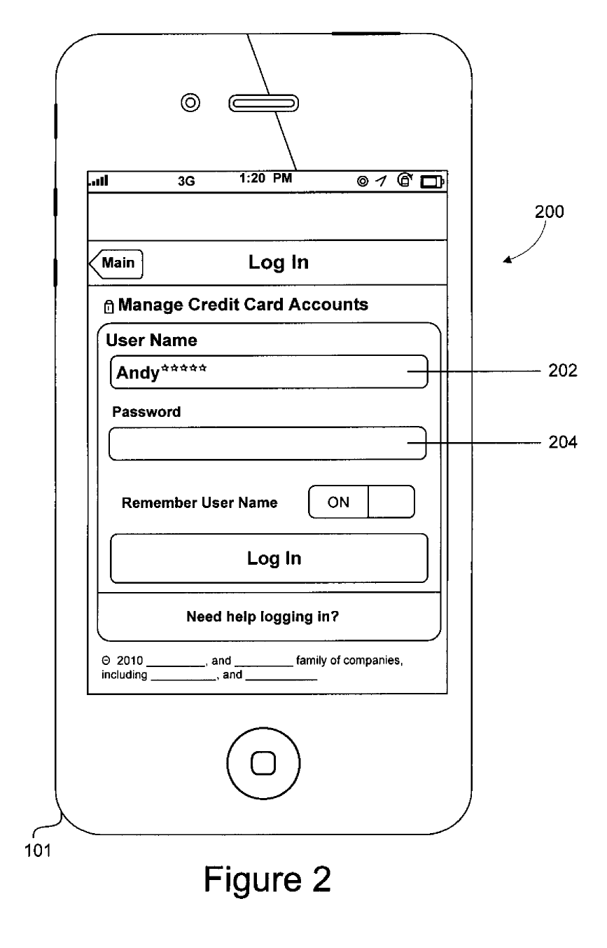

FIGS. 2-19 illustrate exemplary screenshots of an application that may run on a device, including for example, devices such as customer communications device 101, financial institution communications device 102, financial institution branch communications device 104 and/or third party customer information providers communications device 103.

FIG. 2 depicts an exemplary screenshot of a user interface for providing log-in information 200. As illustrated in FIG. 2, a user interacting with, for example, a customer communications device 101 may be presented with log in fields for providing a user name 202 and password 204. The entered information may allow a user access to an application for managing credit card accounts and/or affecting a balance transfer.

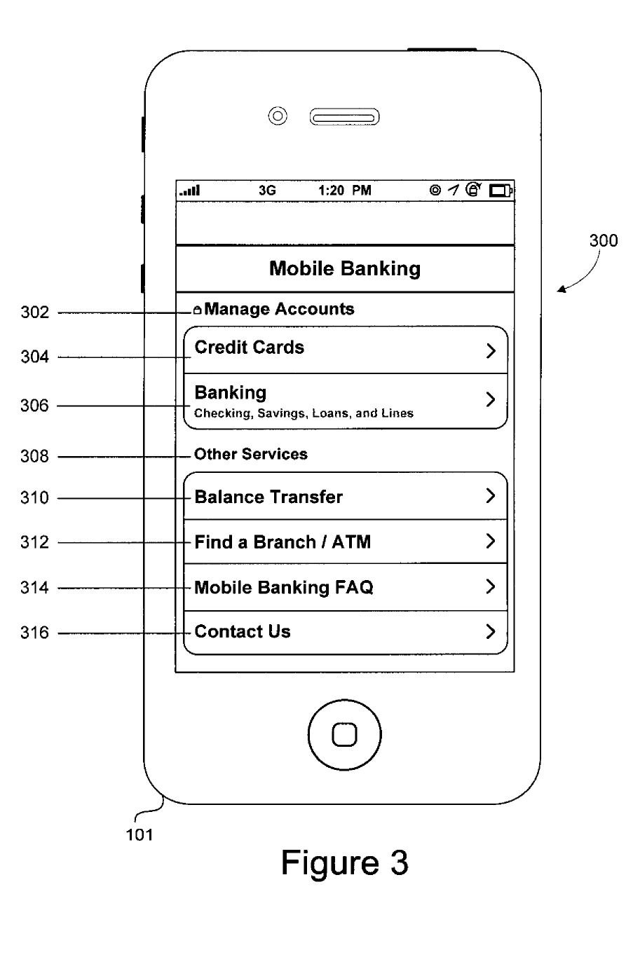

FIG. 3 depicts an exemplary screenshot of a user interface for selecting banking options 300. As illustrated in FIG. 3, a user interacting with, for example, a customer communications device 101 may be provided with a menu for selecting a mobile banking options including manage accounts options 302 and other services options 308. Exemplary options may include manage credit cards 304, manage banking 306, balance transfer 310, find a branch/ATM 312, mobile banking FAQ 314 and/or contact us 316. In exemplary embodiments, a balance transfer option application 310 may be a standalone application.

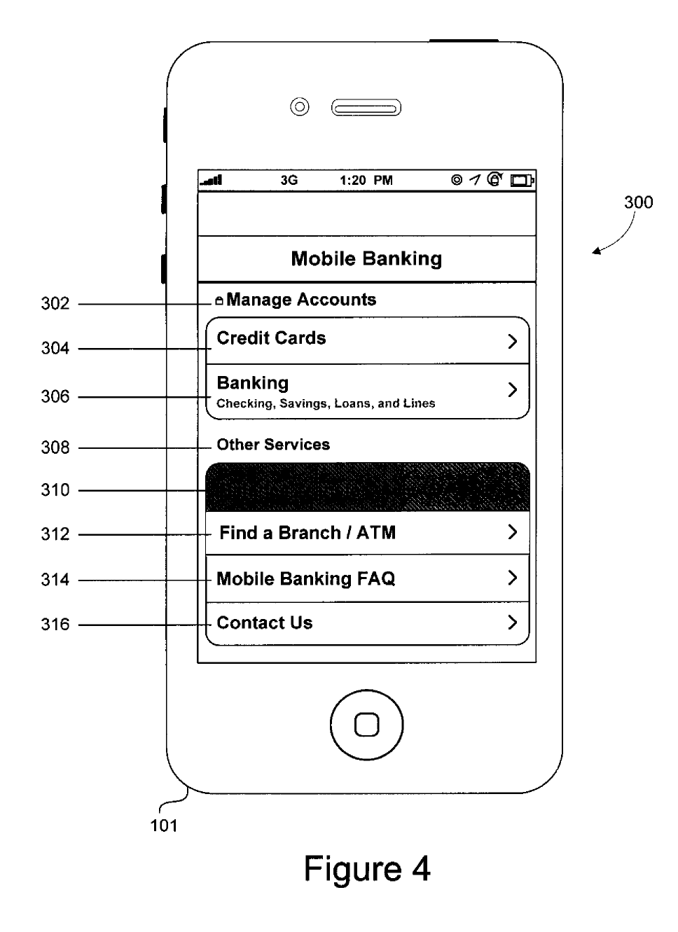

FIG. 4 depicts an exemplary screenshot of a user interface for selecting a balance transfer banking option 300. As illustrated in FIG. 4, a user interacting with, for example, a customer communications device 101 may select the balance transfer option 310 from among the options provided at the mobile banking screen. A user may select the balance transfer option 310 to advance to a balance transfer user interface.

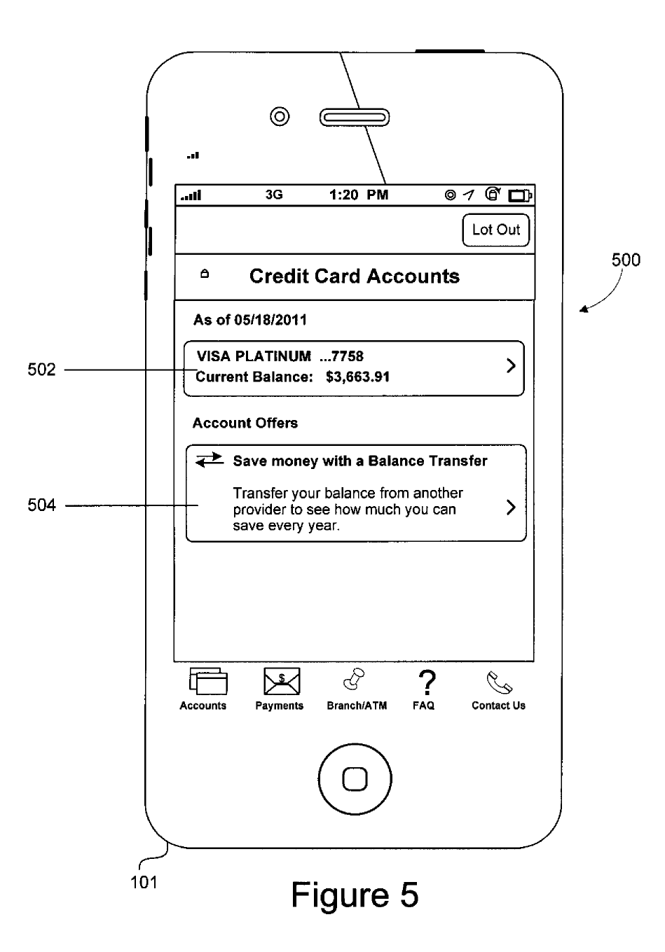

FIG. 5 depicts an exemplary screenshot of a manage credit card accounts user interface 500. As illustrated in FIG. 5, a user interacting with, for example, a customer communications device 101 may be presented with a manage credit card accounts user interface 500. In addition to being presented with one or more credit card accounts to be managed 502, a user may also be presented with various account offers including 504, for example, a balance transfer account offer 504. A user may select a balance transfer account offer 504 to advance to a balance transfer user interface 600.

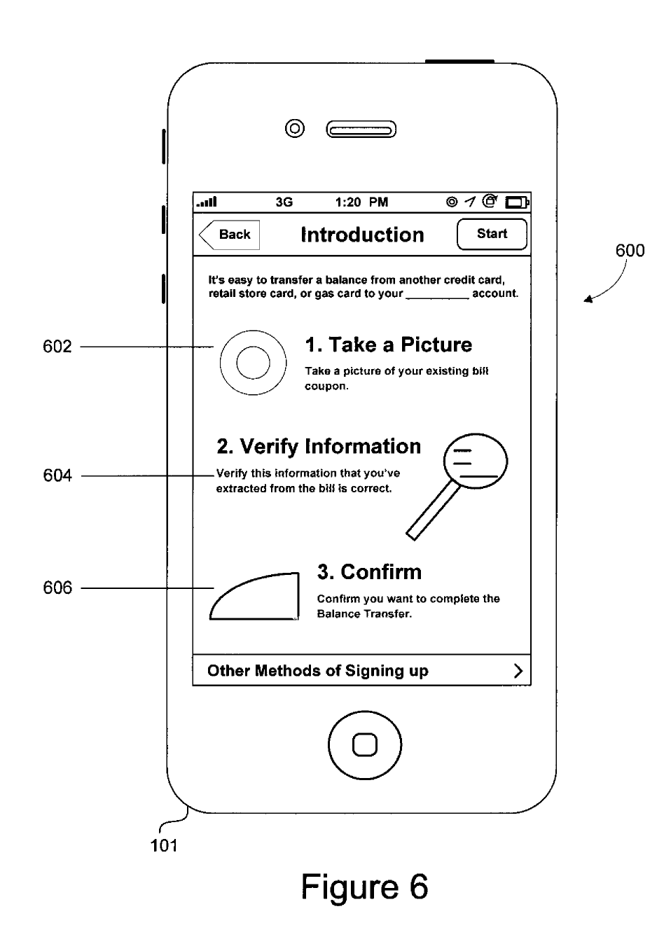

FIG. 6 depicts an exemplary screenshot of a balance transfer user interface 600. As illustrated in FIG. 6, a user interacting with, for example, a customer communications device 101 may be presented with instruction for affecting a balance transfer 600. For instance, a user may be instructed to take a picture of an existing account statement 602, verify account information extracted from the existing account statement 604, and confirm that the user wishes to complete the balance transfer 606.

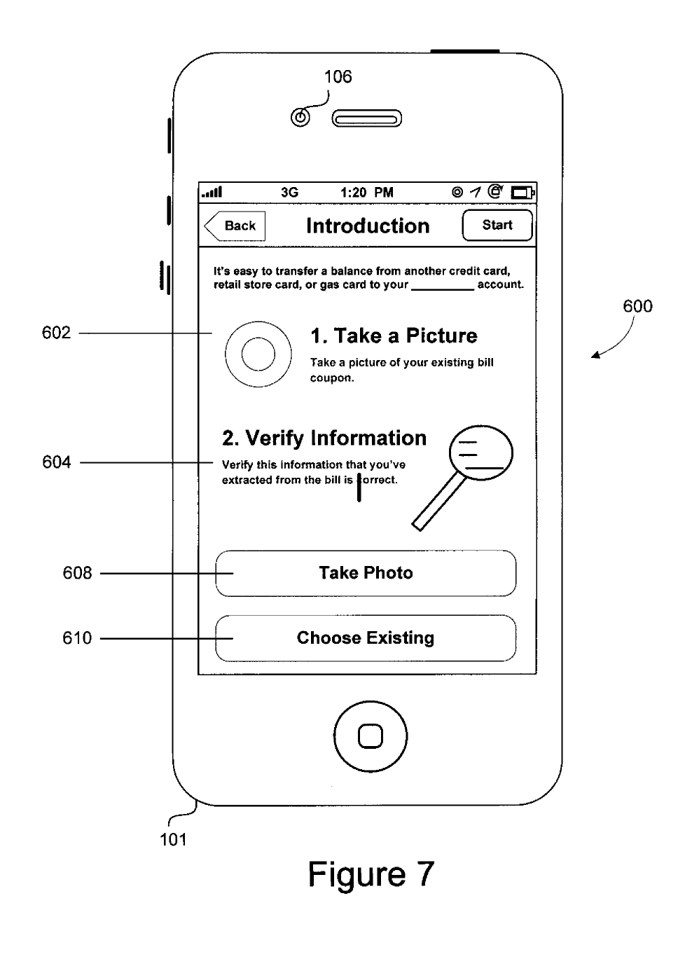

FIG. 7 depicts an exemplary screenshot of a balance transfer user interface 600. As illustrated in FIG. 7, a user interacting with, for example, a customer communications device 101 may be presented with an option to take a photo of an existing account statement 608 or to use an existing account statement that is stored 610 on a customer communications device 101 or accessible to the customer communications device 101 over the network 105. In an exemplary embodiment, the user may take a photo of an existing account statement using a camera 106 built-into a device, such as the customer communications device 101.

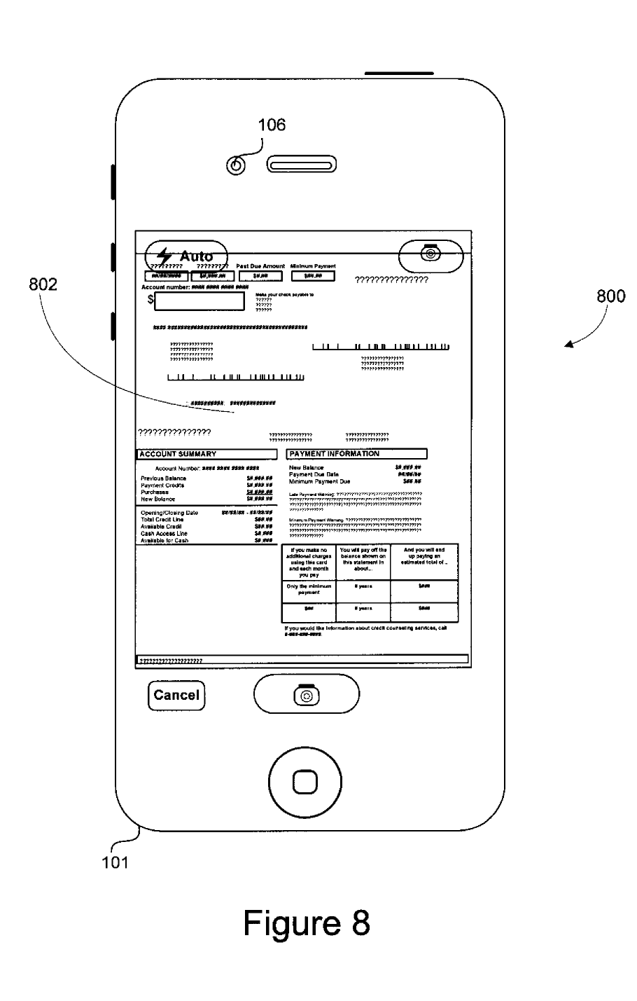

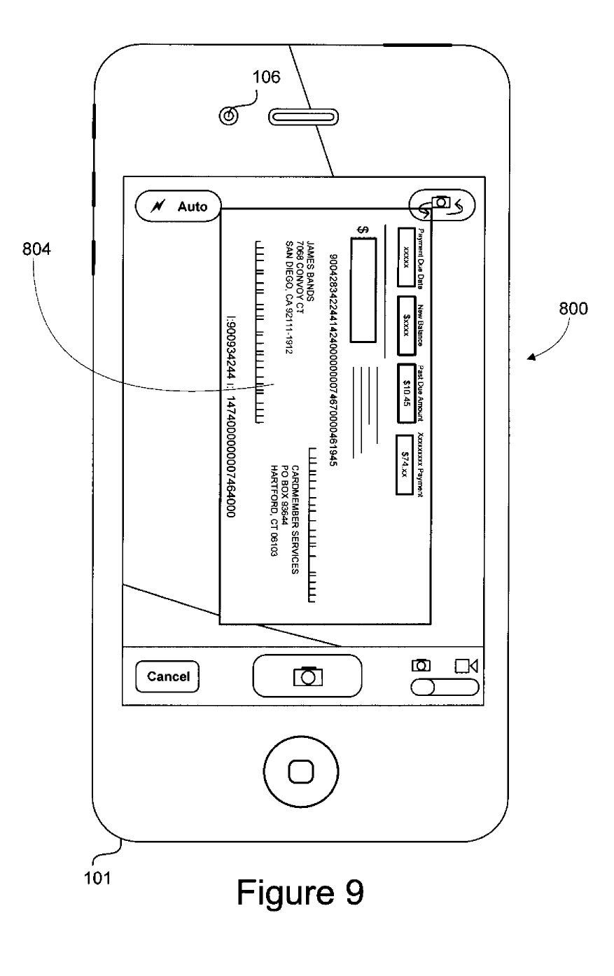

FIGS. 8 and 9 depict exemplary screenshots of captured account statements 800. As illustrated in FIGS. 8 and 9, a user interacting with, for example, a customer communications device 101 may be presented with an image representing a photograph of an existing account statement 802, 804. In various exemplary embodiments, the image may be captured by a camera 106 integrated into the communications device 101, or it may be provided by an external camera. Also, account statements may be downloaded from one or more third-party networks and displayed on the communications device 101. Further, account information may be provided over network 105 by third party customer information providers communications devices 103 and/or financial institution branch communications devices 104.

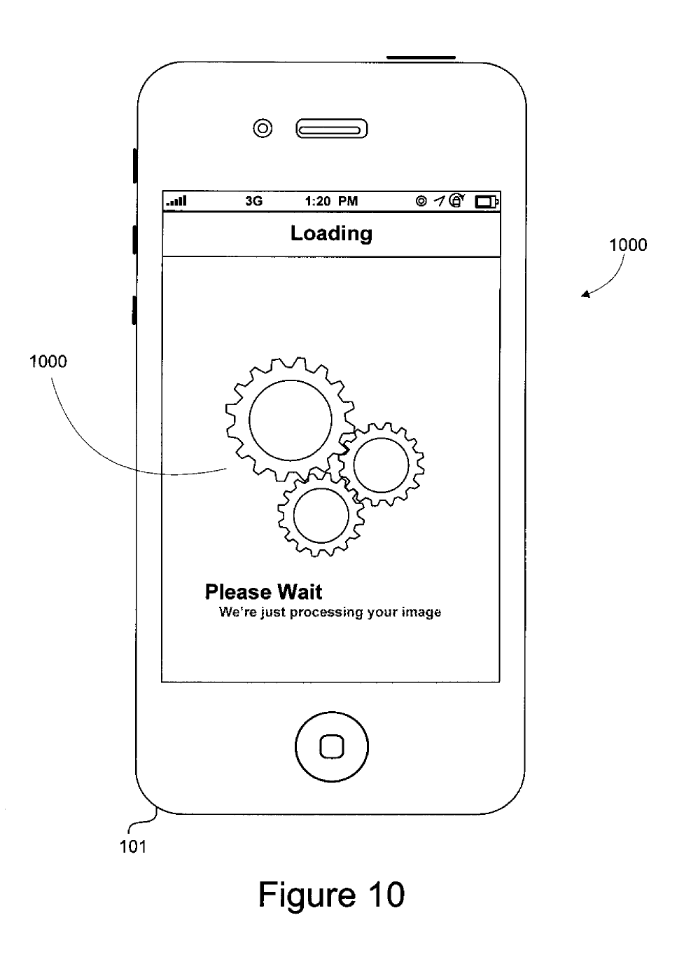

FIG. 10 depicts an exemplary screenshot of an image processing screen 1000. As illustrated in FIG. 10, an application running on, for example, communications device 101 may work to process an image of an existing account statement to extract particular instance. For example, the application may extract information including customer name, customer address, customer account number, balance value, interest rate, and/or payee information from an image of an account statement using an image recognition program or an optical character recognition program. By way of non-limiting example, image recognition technologies developed by Mitek Systems, Inc. of San Diego, Calif. and/or NCR Corporation of Duluth, Ga. may be utilized to extract the information from an image of an account statement. In exemplary embodiments, account information may be extracted from electronic sources, such as .pdf files, Microsoft Excel files, and/or or webpages.

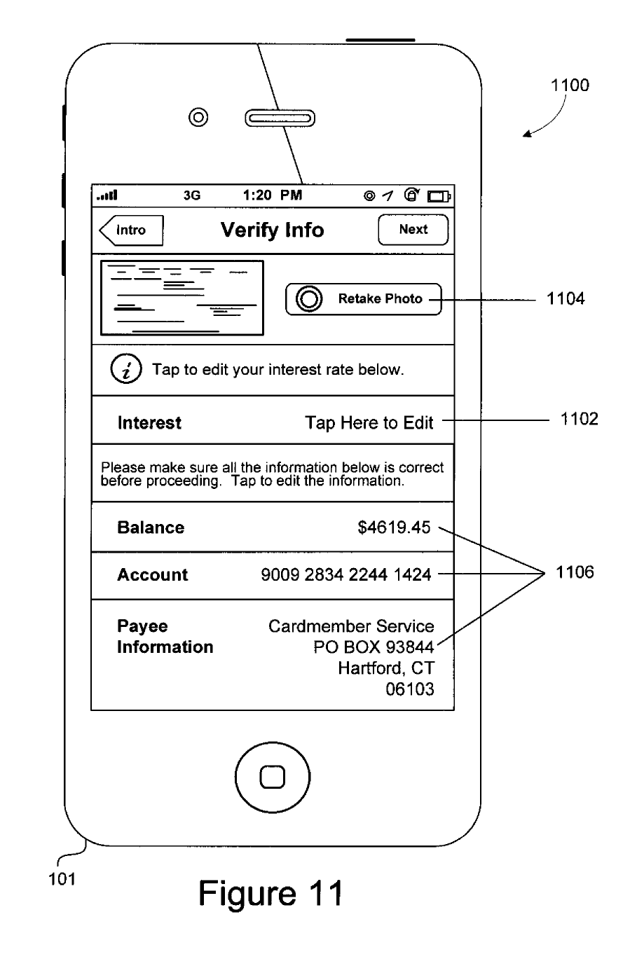

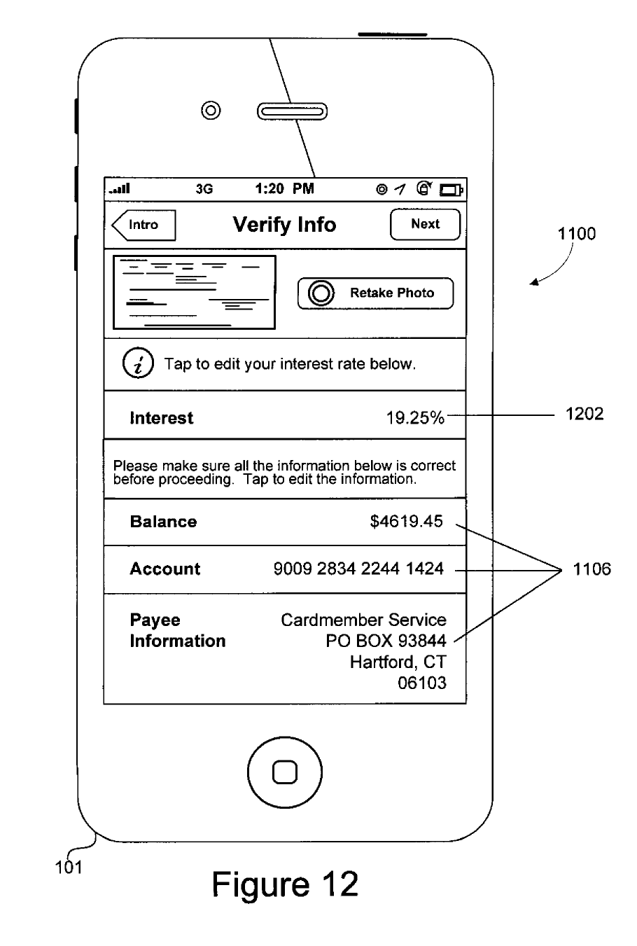

FIGS. 11 and 12 depict exemplary screenshots of extracted account data 1100. As illustrated in FIG. 11, a user interacting with a customer communications device 101 may be presented with pre-populated data fields based on data extracted from an account statement image. The exemplary user interface depicted in FIG. 11 may allow a user to modify her current interest or edit any of the information 1102 that is listed in the pre-populated fields. The user may also opt to retake the photo of the existing account statement 1104. As shown in FIG. 12, the current interest rate 1202 may also be automatically populated if extracted from the existing account statement.

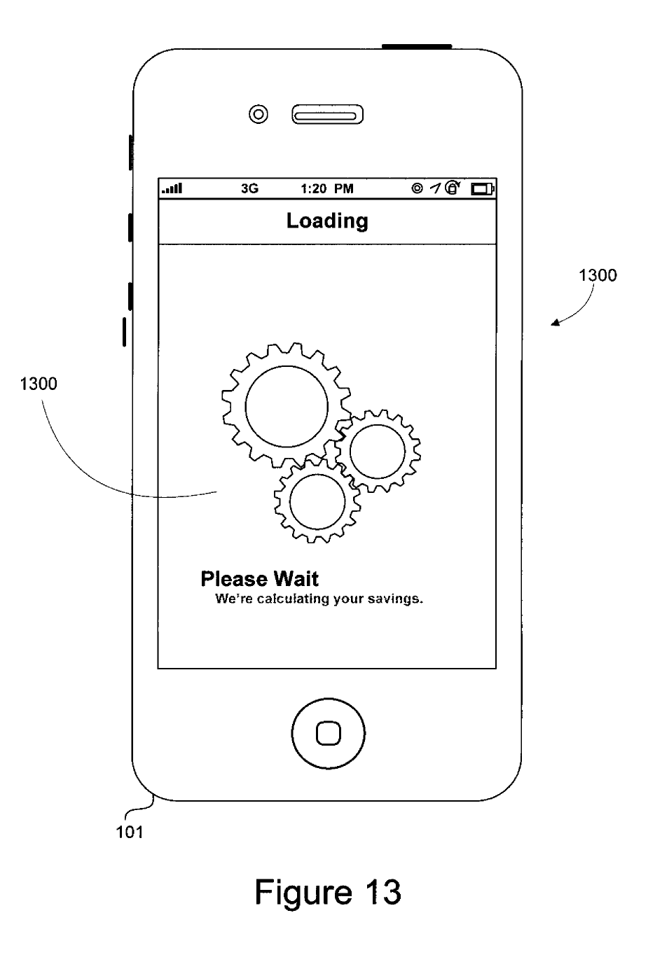

FIG. 13 depicts an exemplary screenshot of a savings calculation screen 1300. As illustrated in FIG. 13, an application running on, for example, a customer communications device 101 may calculate the amount of savings that a customer may realized by completing a balance transfer. This calculation may be based on the current interest rate of the user as compared to the offered interest rate. The balance transfer terms offered to the customer may be determined based on many types of data. By way of non-limiting example, the balance transfer terms may depend upon the amount of the account to be transferred, the credit history of the customer, and/or the income level of the customer.

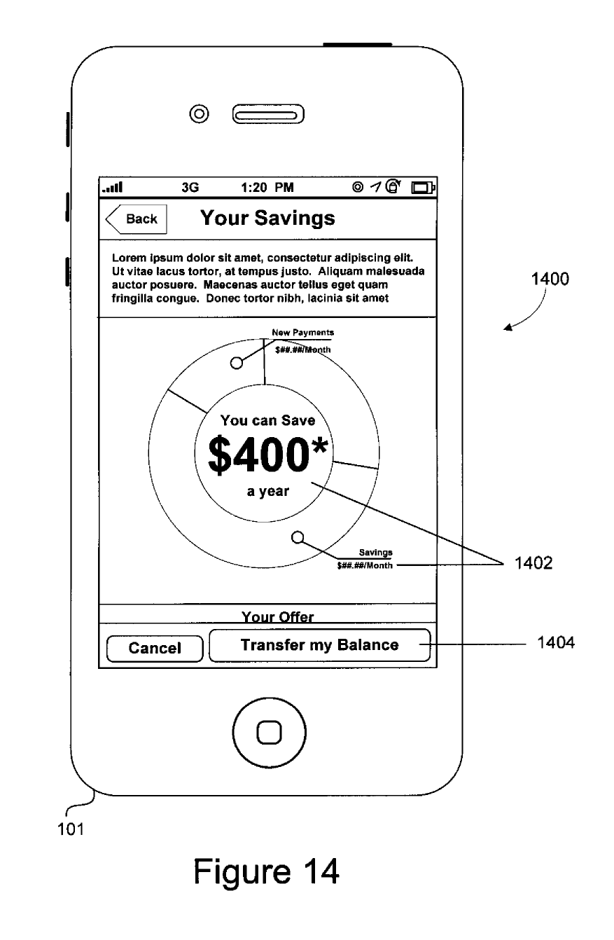

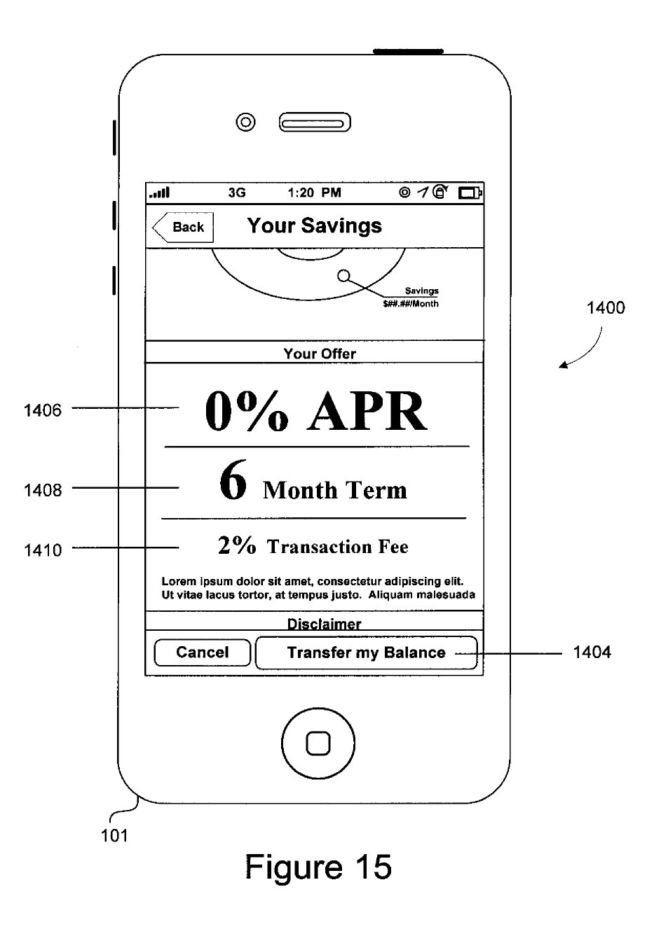

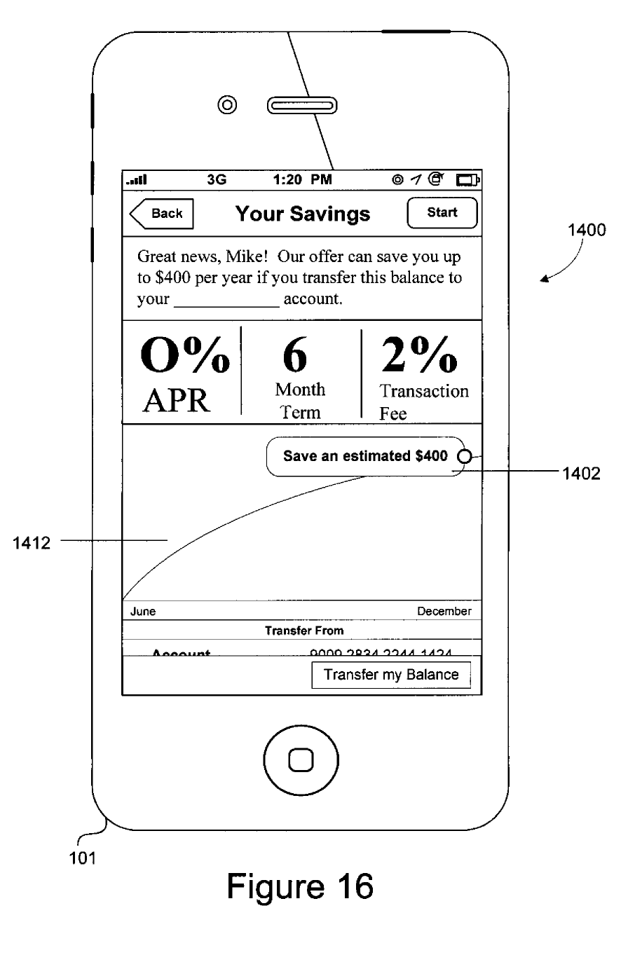

FIGS. 14, 15, and 16 depict exemplary screenshots of savings indication screens 1400. As illustrated in FIGS. 14, 15, and 16, a user interacting with, for example, customer communications device 101 may be presented with an indication of the amount of savings to be realized 1402 by completing the offered balance transfer 1404. As shown in FIG. 14, the savings indication may be numerical and/or graphical 1402. As shown in FIG. 15, the savings indication may also provide details for the current offer, including the offered Annual Percentage Rate (“APR”) 1406, term 1408, and/or transaction fee 1410. As shown in FIG. 16, the savings indication may also include a chart which demonstrates the expected savings 1402 as a factor of time.

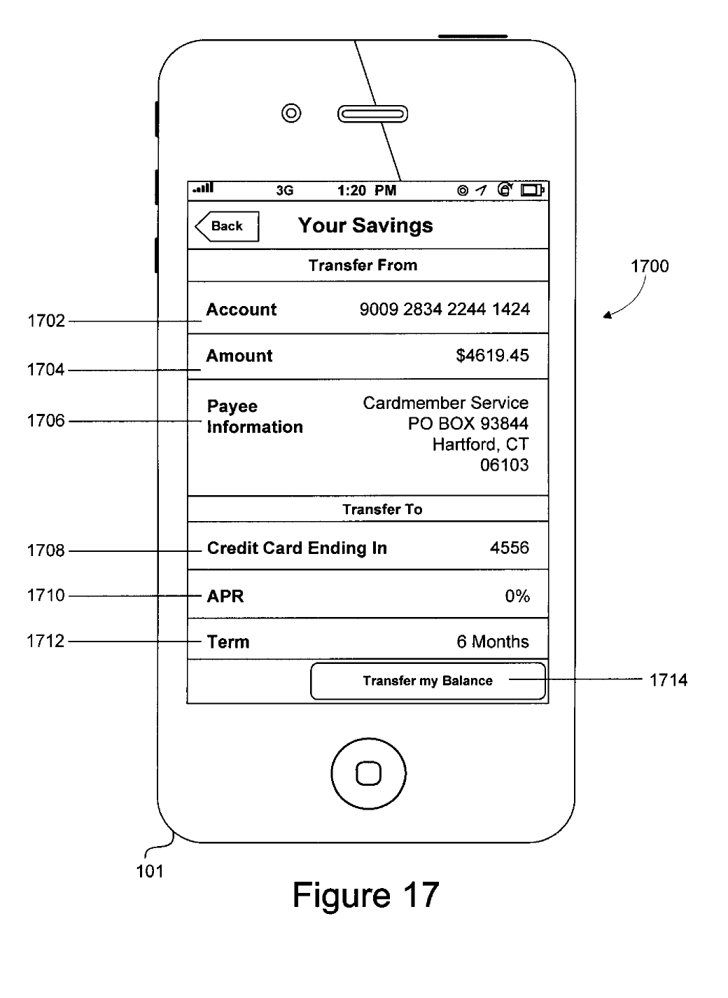

FIG. 17 depicts an exemplary screenshot of a balance transfer screen 1700. As illustrated in FIG. 17, a user interacting with, for example, customer communications device 101 may be presented with a summary of the balance transfer information 1700. Such information may include the existing account number 1702, existing account amount 1704, payee information 1706, new account number 1708, APR 1710, and/or term 1712. The user may be presented with an option to implement the balance transfer. In exemplary embodiments, the balance transfer may be implemented using a mobile device 101.

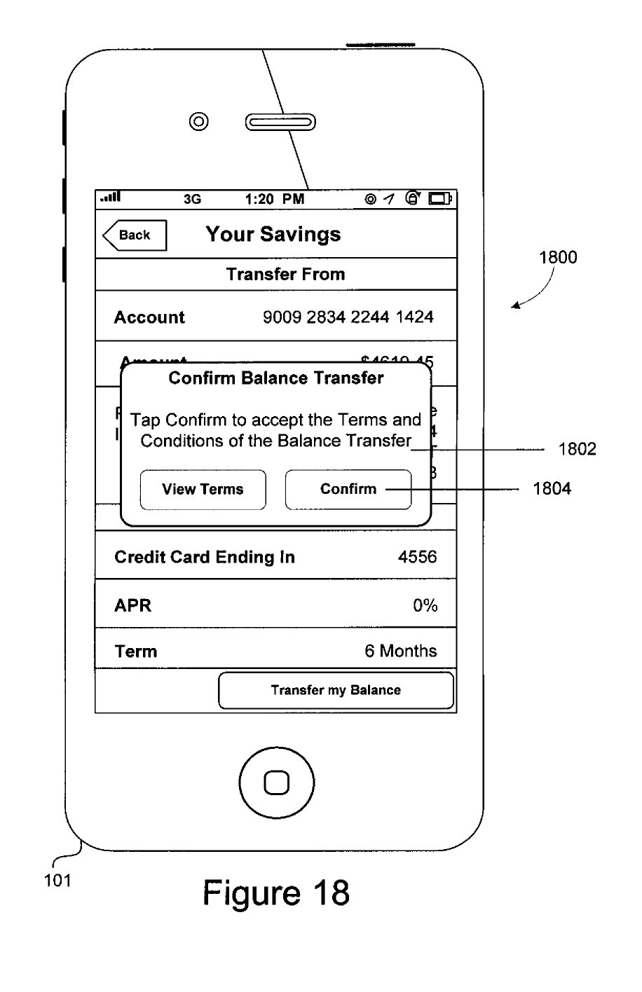

FIG. 18 depicts an exemplary screenshot of a confirm balance transfer screen 1800. As illustrated in FIG. 18, a user interacting with, for example, customer communications device 101 may be asked to view and/or confirm the terms and conditions of the balance transfer 1802. When the user confirms the terms 1804, the balance transfer request may be submitted to a financial institution for processing.

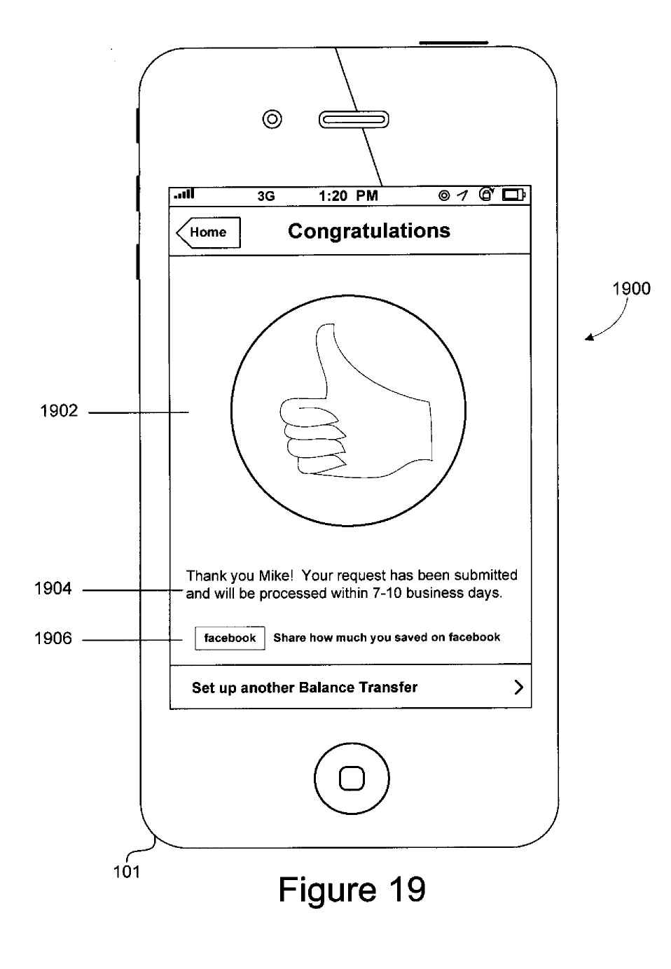

FIG. 19 depicts an exemplary screenshot of a balance transfer confirmation screen 1900. As illustrated in FIG. 19, a user interacting with, for example, customer communications device 101 may be presented with a confirmation message 1902 that the balance transfer request has been submitted to a financial institution. The user may also be presented with a time estimate for completing the balance transfer 1904. In exemplary embodiments, the balance transfer may occur immediately in real time. Further, the user may be presented with an option to share information related to the balance transfer, including the amount saves, on a social network website 1906.

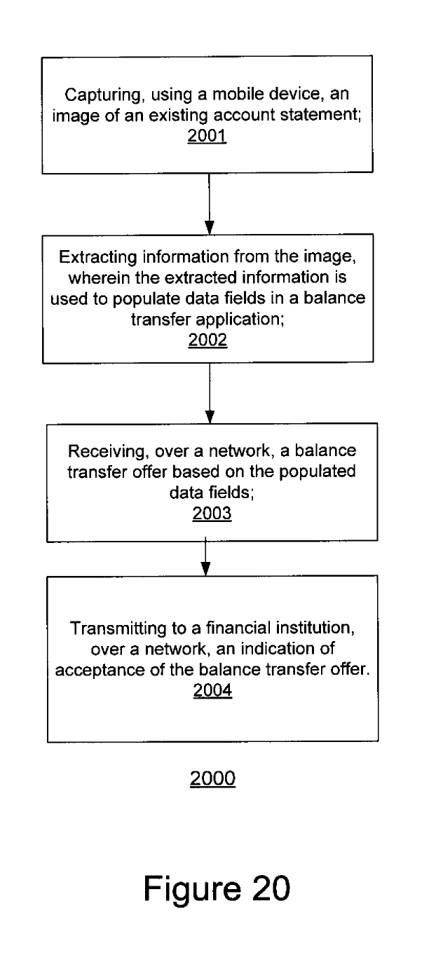

FIG. 20 is a flow chart illustrating a method for providing balance transfers 2000. This exemplary method if provided by way of example. The method 2000 shown in FIG. 20 can be executed or otherwise performed by one or more combinations of various systems. The method 2000 as described below may be carried out by the system for providing balance transfers 100 as shown in FIG. 1, by way of example, and various elements of the systems for providing balance transfers are referenced in explaining the method of FIG. 20. Each block shown in FIG. 20 represents one or more processes, methods, or subroutines in the exemplary method 2000. Referring to FIG. 20, the exemplary method 2000 may begin at block 2001.

In block 2001, the method 2000 may include capturing, using camera on a device such as a mobile device, an image of an existing account statement. By way of example, this captured image may be one such as the captured account statements 802, 804 of FIGS. 8 and 9. The method 2000 may continue at block 2002.

In block 2002, the method 2000 may include extracting information from the image, wherein the extracted information is used to populate data fields in a balance transfer application. By way of example, this extraction of information may result in the extracted account data screens 1100 presented in FIGS. 11 and 12. The method 2000 may continue at block 2003.

In block 2003, the method 2000 may include receiving, over a network, a balance transfer offer based on the populated data fields. By way of example, this balance transfer offer may produce savings indications screens 1400 such as those presented in FIGS. 14, 15, and 16. The method 2000 may continue at block 2004.

In block 2004, the method 2000 may include transmitting to a financial institution, over a network, an indication of acceptance of the balance transfer offer. By way of example, prior to the transmission screens such as the balance transfer screen 1700 of FIG. 17 may be presented. Once a transfer is confirmed, a confirmation screen 1900 such as the screen in FIG. 19 may be provided to a customer communications device 101. The method 2000 may then end.

In various exemplary embodiments, balance transfer offers may only be presented to certain customers or certain potential customers. By way of non-limiting example, balance transfer offers may be presented based on credit worthiness, home address, credit score, income, debt-to-income ration, and/or place of employment. It should be appreciated that, in exemplary embodiments, a balance transfer application may connect to various data sources to determine information about customers and/or potential customers. Based on this data, balance transfer offers may be customized and targeted to certain individuals.

The description above describes user devices, an analysis system, a communication network having network elements that are coupled to each other via one or more links (e.g., physical or logical), various networks within a domain of the communication network, and other elements for coupling customer to the communication network, some of which are explicitly depicted, other of which are not. As used herein, the term “module” may be understood to refer to executable software, firmware, hardware, or various combination thereof. It is noted that the modules are exemplary. The modules may be combined, integrated, separated, or duplicated to support various applications. Also, a function described herein as being performed at a particular module may be performed at one or more other modules and by one or more other devices instead of or in addition to the function performed at the particular module. Further, the modules may be implemented across multiple devices or other components local or remote to one another. Additionally, the modules may be moved from one device and added to another device, or may be included in both devices.

It is further noted that the software described herein maybe tangibly embodied in one of more physical media, such as, but not limited to, a compact disc (CD), a digital versatile disc (DVD), a floppy disk, a hard drive, read only memory (ROM), random access memory (RAM), as well as other physical media capable of storing software, or combinations thereof. Moreover, the figures illustrate various components (e.g., servers, computers, processors, etc.) separately. The functions described as being performed at various components may be performed at other components, and the various components bay be combined or separated. Other modifications also may be made.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for providing mobile balance transfers, comprising:
receiving, over a network from a mobile device, data associated with a balance transfer application, wherein the data is electronically extracted from a captured image of an account statement;
providing, over a network, a balance transfer offer based on the received data; and
receiving, over a network from a mobile device, an acceptance of the balance transfer offer from a mobile device.

2. The method of claim 1, further comprising:
completing the balance transfer.

3. The method of claim 1, wherein the captured image is obtained by photographing the account statement using the mobile device.

4. The method of claim 1, wherein the captured image is obtained by downloading an electronic file from the internet representing the account statement.

5. The method of claim 1, wherein the balance transfer offer is also based on customer data received from a third-party source.

6. The method of claim 1, further comprising:
determining the balance transfer offer based on the received data.

7. A system for providing mobile balance transfers, comprising:
a first computing device that receives, over a network from a mobile device, data associated with a balance transfer application, wherein the data is electronically extracted from a captured image of an account statement;
a processor that determines a balance transfer offer based on the received data;
a second computing device that transmits, over a network to a mobile device, the balanced transfer offer; and
a third computing device that receives, over a network from a mobile device, an acceptance of the balance transfer offer.

8. The system of claim 7, wherein the first computing device, the second computing device, and the third computing device are the same.

9. The system of claim 7, wherein the captured image is obtained by photographing the account statement using the mobile device.

10. The system of claim 7, wherein the captured image is obtained by downloading an electronic file from the internet representing the existing account statement.

11. The system of claim 7, wherein the processor the determines a balance transfer offer also considers customer data received from a third-party source.

12. The method of claim 1, further comprising:
identifying individuals to be provided with a balance transfer application, wherein the individuals are identified based on credit worthiness, home address, credit score, income, debt-to-income ratio, and/or place of employment.

13. The system of claim 6, further comprising:
a processor that identifies individuals to be provided with a balance transfer application, wherein the individuals are identified based on credit worthiness, home address, credit score, income, debt-to-income ratio, and/or place of employment.

14. A non-transitory computer readable medium encoded with computer program code that, when executed, performs the steps of:
extracting data associated with a balance transfer application from a captured image of an account statement;
transmitting the extracted data;
receiving a balance transfer offer based on the transmitted data; and
transmitting an acceptance of the balance transfer offer.

15. The non-transitory computer readable medium of claim 14, further performing the step of:
receiving notification of a complete balance transfer.

16. The non-transitory computer readable medium of claim 14, wherein the captured image is obtained by photographing the account statement using a mobile device.

17. The non-transitory computer readable medium of claim 14, wherein the captured image is obtained by downloading an electronic file from the internet representing the account statement.

18. The non-transitory computer readable medium of claim 14, wherein, wherein the balance transfer offer is also based on customer data received from a third-party source.
